(19) United States
(12) Patent Application Publication
(10) Pub. No.: US 2013/0119302 A1
(43) Pub. Date: May 16, 2013

(54) HEAT TRANSFER ENHANCING AGENT

(71) Applicants: YEN-HAO HUANG, Kaohsiung City (TW); Hung-Wei Chen, Taichung City (TW)

(72) Inventors: YEN-HAO HUANG, Kaohsiung City (TW); Hung-Wei Chen, Taichung City (TW)

(21) Appl. No.: 13/675,079

(22) Filed: Nov. 13, 2012

(30) Foreign Application Priority Data
Nov. 15, 2011 (TW) 100141671

(51) Int. Cl. C09K 5/14

(52) U.S. Cl. CPC C09K 5/14; Y10S 977/775; Y10S 977/81; Y10S 977/811; Y10S 977/902; B82Y 30/00
USPC 252/77; 252/71; 252/73; 252/79; 428/402; 977/775; 977/810; 977/811; 977/902

(57) ABSTRACT

An enhancing agent for increasing heat transfer efficiency is disclosed, which is an additive composed of a nano-scale powder and a micro-scale powder that is to be added into a heat-transfer fluid circulating in an heat exchange system or in a coolant circulating in a cooling system for enhancing the heat conductivity of the heat-transfer fluid or the coolant while helping the tank and the fluid passages used in those systems to maintain clean, and eventually enabling those systems to operate with improved heat dissipation effect. By adding the aforesaid enhancing agent into a cooling system of an internal-combustion engine, the heat shock inside the engine that is originated from the fuel burning in the engine can be reduced, resulting that not only the amount of green house gas emission is reduced, but also the chance of engine juddering that is generally originated from poor heat dissipation can be decreased.

### FIELD OF THE INVENTION

The present invention relates to an agent for enhancing heat transfer efficiency of heat-exchange or cooling devices. The agent composes of a nano-scale powder and a micro-scale powder. When added into a heat-transfer fluid of a heat exchange system or a coolant of a cooling system, the agent helps maintain the tank and the fluid passage clean and increases the thermal conductivity of the fluid. Consequently the efficiency of heat transfer of those systems is enhanced. Using the aforesaid agent in a cooling system of an internal-combustion engine will increase heat dissipation efficiency and reduce the thermal shock that is originated from fuel combustion. This results in a reduction of greenhouse gas emission, engine juddering, engine noise, and fuel consumption.

### BACKGROUND OF THE INVENTION

Conventionally, the performance of internal combustion engines is improved either by introducing certain additives into the fuel to achieve complete combustion, or by adding lubricant into the cylinder of the engine to reduce friction between moving surfaces. For the reduction of nitrogen oxide (NOx) emission in internal combustion engines, it is commonly achieved either by adding a certain reductants into the fuel of the internal combustion engine to remove NOx and thus reduce the NOx concentration in the exhaust, or by guiding the exhaust through a catalyst to remove NOx.

However, it is noted that the engine performance improvement with NOx emission reduction can be achieved by the enhancement of the heat dissipation performance in internal combustion engines through the improvement of heat-transfer efficiency in the cooling system (radiator) of internal combustion engines.

Conventionally, the heat-transfer efficiency of cooling system is improved by adding certain anti-rust additives into the cooling water of the cooling system. By the addition of the anti-rust additives into the cooling water, the generation of water scale or rust sludge in the piping of the cooling system can be suppressed, and thus the heat transfer efficiency will not be adversely affected by the poor thermal conductivity of piping wall and poor cooling water circulation in the piping caused by the water scale or rust sludge deposited on the wall of the piping. However, adding anti-rust additives into the cooling water can at most prevent the deposition of water scale or rust sludge in the piping of the cooling system, but still its effectiveness in improving heat dissipation efficient in internal combustion engine is questionable.

With the advance in nanotechnology, there have already been many studies showing that the heat transfer characteristics of a fluid can be greatly improved by adding nano-scale particles into the fluid, forming a so-called “nanofluid”. For instance, a paper of S.U.S. Choi, entitled “Enhancing Thermal Conductivity of Fluids with Nanoparticles” that is disclosed in D. A. Singer and H. P. Wang, Editors, Development and Applications of Non-Newtonian Flows FED-vol. 231/MD-vol. 66, ASME, New York (1995), pp. 99-106; and a paper of S. U. S. Choi and J. A. Eastman disclosed in U.S. Pat. No. 6,221,275 B1; and so forth.

Moreover, there is another such study disclosed in U.S. Pat. No. 6,858,157 B2, in which an additive comprising a nano-particle size diamond powder is added into the transformer oil for transformers, so as to enhance the thermal capacity and thermal conductivity of the transformer oil, and by doing so, the heat dissipation efficiency of the transformers can be improved. Furthermore, there is another such study disclosed in U.S. Pat. No. 6,695,974 B2, in which nano carbon materials are added into a heat transfer fluid of a closed transfer system for enhancing the thermal conductivity of heat transfer fluid, and thus causing the heat transfer efficiency to be enhanced. There is further another such study disclosed in U.S. Pat. No. 6,432,3230 B2, in which a chemically stabilized nano-particle size powder that is used as an additive in a heat transfer media is disclosed, and the chemically stabilized nano-particle size powder can include particles of nano-scale copper, beryllium, titanium, nickel, iron, alloys or blends thereof. By adding the aforesaid additive into the heat transfer media, the heat transfer capacity and thermal conductivity of the same can be enhanced which are beneficial to the heat transfer efficiency.

In addition, there are already many studies specifically focused on the use of solid nano-particles as a radiator coolant additive in a cooling system for internal combustion engines. One of which is disclosed in U.S. Pat. Pub No. 2005/0062015 A1, in which a radiator coolant additive including strontium mineral powder is added in a radiator coolant, and during operation of an automobile engine, the strontium mineral powder can cause positive ions to be generated in the coolant, and at the same time, negative ions to be generated in the fuel within the cylinders of the engine, and thereafter, these ions can induce an electromagnetic wave around the pistons of the engine, which enhances fuel combustion. Another such study is disclosed in U.S. Pat. Pub No. 2005/0269548 A1, in which a fluid composition including a coolant and a plurality of nano-particles dispersed within the coolant are provided, whereas the plural nano-particles includes glass, silica, pumices, metal compounds that are adapted to react with chloride in the coolant. The plurality of nano-particles substantially increases heat capacity of the coolant and enhances heat transfer efficiency of the fluid composition. Moreover, in U.S. Pat. Pub No. 20080179563 A1, a radiator additive including a composition of powders of a carbon-based semiconductor material and a rare-earth negative ion ore is provided. By introducing the additive into a radiator, it is postulated that the negative ionization of cooling water loaded in the radiator can be caused. In a circulation step of causing the cooling water in which negative ionization has proceeded to continuously circulate around an engine combustion chamber, the inside of the engine combustion chamber is gradually subjected to negative ionization. Then, as the negative ionization within the combustion chamber proceeds, the ionization degree of a mixture gas of gasoline and air introduced into the engine combustion chamber is enhanced and activated. This renders the mixture gas to be combusted and exploded in a substantially complete combustion state, thereby enhancing fuel efficiency and cleaning an exhaust gas. In addition, there is a nanometer heat-conducting water solution for use in car cooling system disclosed in TW Pat. No. I258,534 and U.S. Pat. No. 7,374,698 B2, in which the nanometer heat-conducting water solution is formed by mixing a Al₂O₃ powder (1.1 vol %) having 3-10 nanometer particle size with a TiO₂ powder (1.1 vol %) having 3-10 nanometer particle size, wherein the obtained solution is then mixed with a diluent (93 vol %), and dispersing agents (3.43 vol %) and an emulsifying agent (1.37 vol %). When the obtained stable nanometer heat-conducting water solution is added to a water tank of the car radiator, it is postulated that the TiO₂ cleans limescale and the emulsifying agent adheres to wall surfaces of water jackets to allow Al₂O₃ to release energy continuously. Moreover, the nanometer scale TiO₂ materials speed up the micro-explosion of the cooling water so as to optimum the cooling effect and increase the heat-dispersing efficacy significantly.

### SUMMARY OF THE INVENTION

The object of the present invention is to provide an agent for enhancing heat transfer efficiency. The agent composes of a nano-scale powder and a micro-scale power. When added into a heat-transfer fluid circulating in an heat exchange system or in a coolant circulating in a cooling system, the agent enhances the thermal conductivity of the heat-transfer fluid or the coolant by the circulation of the nano-scale particles, and helps the tank and the fluid passages used in those systems to maintain clean by the circulation of the micro-scale particles. Consequently, using the aforesaid enhancing agent in a cooling system of an internal-combustion engine will enhance heat dissipation efficiency of the internal combustion engine, reduce the thermal shock inside the engine that is originated from the fuel combustion in the engine, reduce the greenhouse gas emission, decrease the chance of engine juddering that is generally originated from insufficient lubricant viscosity or oil film cutoff in cylinders due to engine overheating, reduce engine noise, and minimize fuel consumption. The agent also helps achieve complete combustion, decrease carbon deposition, and lower the concentration of HC and CO in the exhaust.

To achieve the above object, the present invention discloses an agent for enhancing heat transfer efficiency. The agent is a mixture of a nano-scale powder and a micro-scale power that is to be introduced into the cooling system as an additive to enhance heat dissipation efficiency of the internal combustion engine.

The enhancing agent is an additive to the heat transfer media of any internal combustion engine adapted for automobiles, ships, or other machinery, which is characterized in that: the agent starts to function the moment when an internal combustion engine is activated without having to wait for a period of time for heating, unlike the preheating process of a catalytic de-NOx converter that can function properly only when its catalyst bed is heated to a specific high temperature.

In an embodiment, the mixture of the nano-scale powder and the micro-scale power can be manufactured into the form of an ointment, a pallet, a flake, a button, or a block which can be dispersed easily in a circulating coolant. Consequently, not only the costs of manufacturing, packaging, storage, and transportation of the enhancing agent are reduced, but also it is easy to use.

In addition, since the enhancing agent can increase the heat conductivity of the coolant by the circulation of the nano-scale power and also help the tank and the fluid passages used in the circulation to maintain clean by the circulation of the micro-scale powder, it is not necessary to have the nano-scale powder and the micro-scale powder made of materials capable of enhancing thermal capacity of the coolant, or causing ionization in the coolant, or even capable of rendering fuel in an engine to be combusted and exploded in a substantially complete combustion state, which is significantly different from those prior inventions mentioned above. Therefore, each of the nano-scale powder and the micro-scale powder can be made of any chemically and physically stable material, and is not limited to strontium mineral powder, glass, silica, pumices, carbon-based semiconductor material, rare-earth negative ion ore, titanium oxide powder, or aluminum oxide powder, that are used in the above mentioned inventions.

Further scope of applicability of the present application will become more apparent from the detailed description given hereinafter. However, it should be noted that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying drawings which are provided for illustration only, and thus are not limitative of the present invention and wherein:

FIG. 1 is a time diagram showing the effectiveness of NOx emission reduction with and without the use of an agent of the present invention that are measured before the exhaust go through the catalytic de-NOx converter.

FIG. 2 is a time diagram showing the effectiveness of NOx emission reduction with and without the use of an agent of the present invention that are measured after the exhaust go through the catalytic de-NOx converter.

FIG. 3 is a time diagram showing the effectiveness of CO emission reduction with and without the use of an agent of the present invention that are measured before the exhaust go through the catalytic de-NOx converter.

### DESCRIPTION OF THE EXEMPLARY EMBODIMENTS

For your esteemed members of reviewing committee to further understand and recognize the fulfilled functions and characteristics of the invention, several exemplary embodiments cooperating with detailed description are presented as the follows.

The enhancing agent provided in the present invention is substantially a mixture of a nano-scale powder and a micro-scale powder, in which each particle of the nano-scale powder is formed with a particle size smaller than 100 nanometers, and each particle of the micro-scale powder is formed with a particle size ranged between 100 nanometers and 500 micrometers.

In an embodiment of the invention, preferably the weight of the nano-scale powder is larger than 10% of the gross weight of the enhancing agent.

In addition, the enhancing agent of the present invention is adapted to be added into a coolant, whereas the coolant can be a fluid selected from the group consisting of: water, a mixing solution of water and ethylene glycol, and of water and propylene glycol.

Moreover, the enhancing agent of the present invention is substantially a solid particle powder with good physical and chemical stabilities made of non-corrosive materials selected at least one from the group consisting of metals, alloys, non-metallic materials, metallic compounds, and non-metallic compounds.

In an embodiment of the invention whereas the enhancing agent is made of a metal, the metal should be selected from transition metals with high stability, such as titanium, vanadium, chromium, cobalt, nickel, iridium, zirconium, niobium, molybdenum, rhodium, palladium, tantalum, tungsten, platinum, silver or gold. In another embodiment of the invention whereas the enhancing agent is made of a metallic compound, the metallic compound can be a material selected from the group consisting of: a transition metal oxide, an alkaline earth metal compound, an oxide of a metal belonging to 13rd Group of the Periodic Table; or additionally the metal compound is a material selected from the group consisting of: metal carbides and metal nitrides. When the enhancing agent is made of a transition metal oxide, the transition metal oxide is a material selected from the group consisting of: titanium oxide (TiO₂), cooper oxide, iron oxide, and molybdenum oxide (MoO₂); when the enhancing agent is made of an alkaline earth metal compound, the alkaline earth metal compound can be magnesium oxide (MgO); and when the enhancing agent is made of an oxide of a metal belonging to 13rd Group of the Periodic Table, the an oxide of a metal belonging to 13 Group of the Periodic Table can be aluminum oxide (Al₂O₃). In addition, when the enhancing agent is a non-metallic material, the non-metallic material can be a material selected from the group consisting of: carbon or graphite.

In an embodiment, the enhancing agent of the invention can further be additionally doped with another agent selected from the group consisting of: a dispersant, an excipient, a disintegrant, a coloring agent, and a bacteriostatic agent; that are all mixed in water.

The ability of a solid powder for enhancing the heat transfer efficiency of a coolant is determined depending upon the concentration of the solid powder that is doped in the coolant. Generally speaking, within a specific range of concentration, the more solid powder there is contained in a coolant, the higher heat transfer efficiency there will be for the coolant. However, if there is too much such solid powder contained in a coolant, the circulation of the coolant in a cooling system might be adversely affected, i.e., the circulation may be clogged. It is noted only a minute amount of such solid powder that is added into a coolant will be sufficient for heat transfer ability enhancement, and experimentally, the amount of solid powder that is even only about 0.01% of the coolant in volume will be sufficient for causing significant enhancement in the coolant heat transfer ability. Therefore, the coolant should be added with as much solid powder as possible, only if the adding of the solid powder is not going to cause any clog to the circulation of the coolant. Nevertheless, in view of cost-effectiveness, the amount of such solid powder that is added in a coolant preferably less than 0.1% of the coolant in volume, or at most not more than 0.5% of the coolant in volume.

It is note that the nano-scale powder and the micro-scale powder can each be made of a chemical process or a physical process. In view of the convenience in transportation, storage and application, the enhancing agent of the invention can be made into an button-shaped tablet, a powder, an ointment or a cream.

As most powders, especially the nano-scale powder, can easily gathered into clumps, the powders used in the present invention are generally doped with certain dispersants for improving the separation of particles in the powders so as to prevent settling or clumping. Operationally, the coolant in a cooling system of an internal combustion engine is being driven to circulate all the time when the cooling system is activating, so that the disclosed enhancing agent comprising the nano-scale powder and the micro-scale powder that is made into an button-like tablet or block-like tablet can easily be broken back into the original powders by the circulating coolant. Nevertheless, for further enabling the powders to be rapidly and uniformly dispersed without any aggregation, the enhancing agent of the present that is made into the button-like tablet or block-like tablet are generally being doped with a specific amount of dispersants.

Both the anionic dispersants and the non-anionic dispersants can be used as additives for the enhancing agent of the invention. However, the dosage of the dispersant to be doped into the enhancing agent of the invention should be controlled properly that it should not excess a specific range whereas the specific range is determined by the type of powder used in the enhancing agent of the invention. In addition, for promoting the button-like or block-like enhancing agent to disslove rapid in the circulating coolant, such button-like or block-like enhancing agent of the present invention can further be doped with disintegratants. Accordingly, the disintegratant can be made of a material selected from the group consisting of: croscarmellose sodium, sodium starch glycolate, crospovidone NF, sodium carbonate, and sodium hydrogen phosphate. It is noted that the disintegratants that are doped in the button-like or block-like enhancing agent can also acting as excipients for the button-like or block-like enhancing agents. Moreover, the enhancing agent of the invention can also be doped with a proper amount of coloring agents, or bacteriostatic agents, and so on.

In an embodiment of the invention, the enhancing agent is made into an button-like tablet or a block-like tablet using a process comprising the following steps: mixing the aforesaid additives, including dispersants, excipients, disintegrants, coloring agents, and bacteriostatic agents, with water for allowing the same to be distributed evenly in the water and also dissolved therein; mixing a powder-like enhancing agent of the invention with the aforesaid solution for allowing the same to be distributed evenly so as to form a semi-product ready to be made into tablets; using a dry granulation means or a wet granulation means for compacting and size reducing of the semi-product into tablets. If the dry granulation means is used, the dispersant that is to be doped into the powder-like enhancing agent should have high water solubility and can function properly with little dosage so as to prevent the semi-product from containing too much, since for ensuring the dry granulation to be performed smoothly. However, if the so-achieved semi-product is still to wet for the dry granulation means, an additional step should be taken for drying the semi-product prior to the dry granulation step. On the other hand, the wet granulation means can be performed in the existence of a significant amount of moisture. Nevertheless an additional step should still be taken for drying the semi-product prior to a proper moisture prior to the wet granulation step.

In addition, when the enhancing agent is being prepared as cream or ointment, it can be achieved simply by adding a proper amont of water into the aforesaid semi-product while enabling the ingredients to be mixed uniformly into a cream-like or ointment-like mixture. Nonetheless, for achieving a good mixture of cream or ointment, it is required to have a proper amount of suspending agent to be added into the mixture for prevent any solid-liquid separation phenomenon from happening.

Moreover, the enhancing agent of the invention is able to function and cooperate properly with other common additives, such as preservatives, rust inhibitors, antifreezers, etc., since those other additives are generally being added directly into the coolant and thus the adding of the enhancing agent of the invention into the coolant is not in any way affecting the application of those other additives. It is noted that a proper amount of release agent can be doped into the enhancing agent of the invention for allowing a granulation process to be performed smoothly when the enhancing agent is to be made into button-like tablets or a block-like tablets.

The enhancing agent of the invention is designed to be used in all kinds of systems with heat transfer liquids circulating therein, that are exemplified by the embodiment provided hereinafter whereas those embodiments are adapted for the cooling system of internal combustion engines. However, the aforesaid embodiments along with the descriptions relating to the cooling systems and internal combustion engines are only used for illustration only, since various changes and modifications within the spirit and scope of the disclosure will become apparent to those skilled in the art from this detailed description.

In an Embodiment I, the enhancing agent of the invention is formed as an button-like tablet using the following formula:
powder dispersant (in liquid state): 25 parts;
coloring agent: 1 part;
bacteriostatic agent: 0.25 part;
disintegrant (Sodium Starch Glycolate): 25 parts;
deionized water: 210 parts;
nano-scale power (TiO₂ in particle size <100 nm): 550 parts;
micro-scale power (TiO₂ in particle size between 0.2-50 μm): 450 parts;
whereas, the moisture containing in the formula is removed by the use of drying process after being pressed into tablet.

In an Embodiment II, the enhancing agent of the invention is formed as an button-like tablet using about the same formula of the Embodiment I, but is different in that: the 550 parts of the nano-scale power (TiO₂) is replaced by 600 parts of the nano-scale power (TiO₂), while the 450 parts of the micro-scale power (TiO₂) is replaced by 400 parts of the nano-scale power (TiO₂) in particle size between 0.2-40 μm; and similarly, the moisture containing in the formula is removed by the use of drying process after being pressed into tablet.

In an Embodiment III, the enhancing agent of the invention is formed as an button-like tablet using about the same formula of the Embodiment I, but is different in that: the 550 parts of the nano-scale power (TiO₂) is replaced by the same parts of Al₂O₃ nano-scale power; and then similarly, the moisture containing in the formula is removed by the use of drying process after being pressed into tablet.

In an Embodiment IV, the enhancing agent of the invention is formed as an button-like tablet using about the same formula of the Embodiment I, but is different in that: the 550 parts of the nano-scale power (TiO₂) is replaced by the same parts of ZnO nano-scale power; and then similarly, the moisture containing in the formula is removed by the use of drying process after being pressed into tablet.

In an Embodiment V, the enhancing agent of the invention is formed as an ointment using about the same formula of the Embodiment I, but is different in that: the doped deionized water is increased from the original 210 parts to 700 parts so as to achieve an ointment-like product.

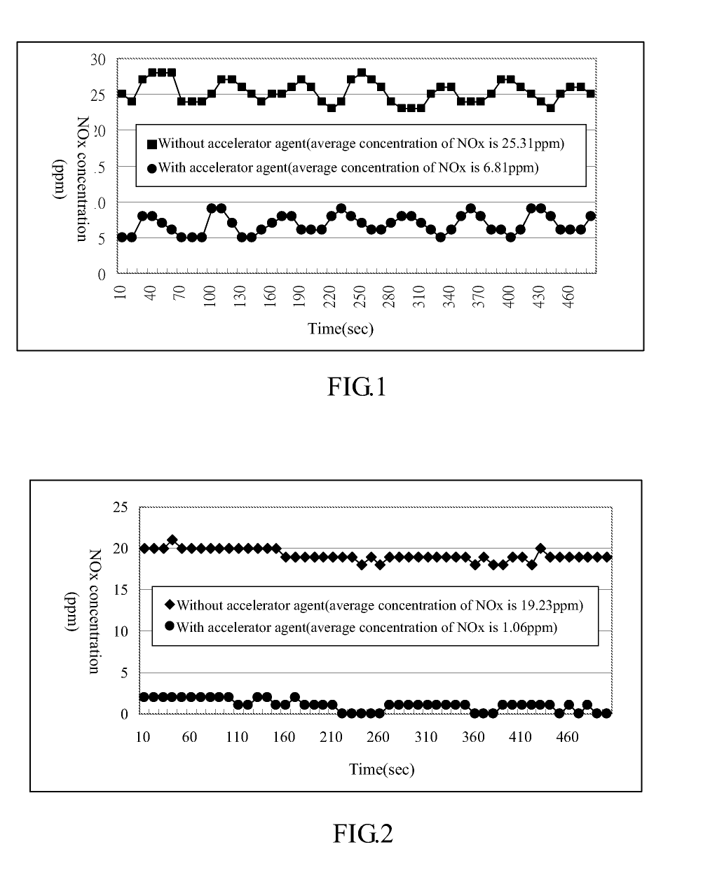

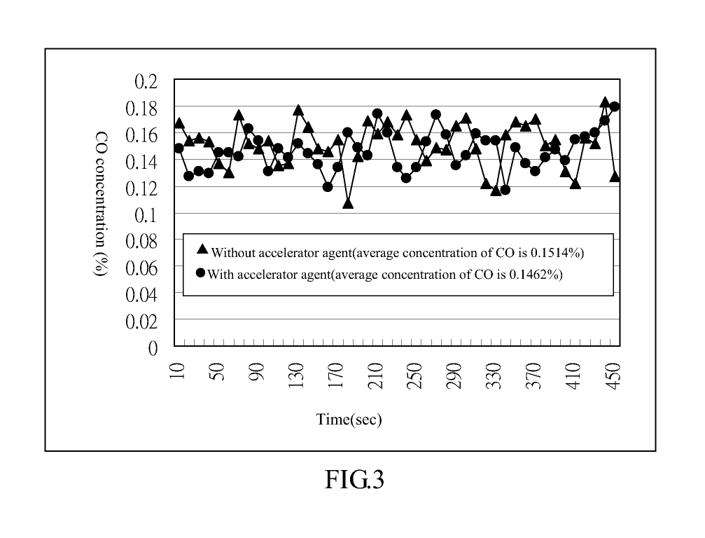

In an experiment for evaluating the effectiveness of the enhancing agent in the reduction of NO and CO emission, the concentration variation of NO and CO in the exhaust of a vehicle before and after the enhancing agent of the invention is added into the coolant of the vehicle is obtained using the following steps: (1) a 1600 c.c. sedan is provide which is manufactured 2 years and four months before and had accumulated a mileage of 23048 miles; and on the exhaust pipe of the sedan, there are two metal tubes of 6 mm inner diameter to be attached respectively at positions in front of and rear to the catalytic de-NOx converter while using Teflon tubes to connect the two metal tubes to be connected to a NOₓ/CO detector for guiding the exhaust of the sedan to the NOₓ/CO detector so as to measure the concentrations of NOₓ and CO in the exhaust; (2) opening the cap of the sedan's water tank for topping the water tank of the sedan by a coolant and then closing the tank cap; (3) the engine of the sedan is started so as to measure and record continuously the concentrations of NOₓ and CO in the exhaust for three minute at an idle speed of 1600 rpm; and consequently, as shown in FIG. 1 and FIG. 2, the average NOₓ concentration that is measured at the position in front of the catalytic de-NOx converter is 25.31 ppm and that measured rear to the catalytic de-NOx converter is 19.23 ppm, and in addition the CO concentration that is measured at the position in front of the catalytic de-NOx converter is 0.1514%, as shown in FIG. 3. It is noted that since the catalytic de-NOx converter is not designed for CO reduction, there will be no need to measure the CO concentration at the position rear to the catalytic de-NOx converter; (4) After the aforesaid measurement is completed, the engine is stopped and then the tank cap is opened after the coolant therein is cooled down for allowing an enhancing agent, i.e. 4.5 g of the additive disclosed in the foregoing Embodiment I, to be dropped into the water tank; (5) the engine is started again while allowing the engine to run for about 15 minutes at the same idle speed of 1600 rpm so as to enable the enhancing agent to dissolve and distribute evenly in the coolant, and then concentrations of NO and CO in the exhaust are measured and recorded in the same way that is described in step (3), and consequently, as shown in FIG. 1 and FIG. 2, the average NO concentration that is measured at the position in front of the catalytic de-NOx converter is 6.81 ppm and that measured rear to the catalytic de-NOx converter is 1.06 ppm, and in addition the CO concentration that is measured at the position in front of the catalytic de-NOx converter is improved to 0.1465 from the prior 0.1514%, as shown in FIG. 3.

From the foregoing comparison, not only the enhancing agent of the invention can work greatly for reducing NO emission, but also it can work better than the catalytic de-NOx converter in view of CO emission reduction, that is evident in that the catalytic de-NOx converter can be cause the concentration of NO in the exhaust to drop from 25.31 ppm to 19.23 ppm, while after adding the enhancing agent of the invention, the concentration of NO in the exhaust is decreased to 6.81 ppm, as shown in FIG. 1. Although the reduction of CO emission using the enhancing agent of the invention is not as good as in the reduction of NO_{R}, it can still cause the CO emission to drop from 0.1514% to 0.1462%, showing that the enhancing agent of the invention can also work for CO emission reduction.

In another experiment for evaluating the effectiveness of the enhancing agent in the reduction of fuel consumption, the effectiveness of fuel consumption reduction of a vehicle before and after the enhancing agent of the invention is added into the coolant of the vehicle is obtained using the following steps: (1) various sedans of different brands and model years that are to be driven routinely on different paths by different driving modes are provided while allowing the brands, models and manufacture years of those sedans to be registered; (2) after filling up the fuel tanks of those sedans at a gas station, the mileages along with the registration dates of those sedans are recorded; (3) the sedans are provided to be driven on their respective routine paths and driving modes and to have their fuel tanks filled as they usually do, while enabling the amount of fuel along with the current mileage on each fill-up to be recorded; (4) the step (3) is performed repetitively until the mileage of those sedans achieve a specific value, i.e. a mileage between 800 km and 1000 km, and then after filling up the fuel tanks for one last time, similarly the amount of fuel of this filling-up along with the current mileage are recorded; (5) according to the data obtained from step (2) to step (4), the total amount of fuel that are used during the experiment and the total mileage that is driven in this experiment period can be obtained, and consequently, the average fuel consumptions for those sedans without using the enhancing agent of the invention can be calculated; (6) After the aforesaid calculation is completed, the engine is stopped and then the tank cap is opened after the coolant therein is cooled down for allowing an enhancing agent to be dropped into the water tank in a dosage disclosed in Table I; (7) according to the data obtained from step (2) to step (5), the average fuel consumptions for those sedans using the enhancing agent of the invention are calculated.

As disclosed in Table I, enhancing agents that are composed of different nano-scale powders and different micro-scale powders are actually very effective in fuel consumption reduction by more than 10%. Moreover, experimentally, the amount of fuel consumption reduction that an automobile can achieve by the use of the enhancing agent of the invention is very much related to the performance of the automobile, that is, the influence of the enhancing agent upon those automobiles whose performance is comparatively better and has lower fuel consumption is far less than those are worse. Nevertheless, either way the enhancing agent of the invention has proven to be very effective in fuel consumption reduction. Moreover, it is noted that the engine rpm at idle speed of any vehicle after applying the enhancing agent of the invention is dropped significantly, proving that the enhancing agent of the invention is effective in fuel consumption reduction.

TABLE I
Fuel economy test in vehicles using the agent of the present invention

| | | | Enhancing agent of the | Usage | Average mileage | |
|---|---|---|---|---|---|---|
| Tested automobiles | | | present invention | quantity (g) | per liter (km) | Decrasing (%) |
| H | Manufacture year | 1995 | Embodiment I | 0 | 9.5 | 17.89 |
| | Cylinder volume (cc) | 1,600 | | | | |
| | Mileage before test (km) | 108,000 | | 4.5 | 11.2 | |
| Y | Manufacture year | 1994 | Embodiment II | 0 | 9 | 16.67 |
| | Cylinder volume (cc) | 1,600 | | | | |
| | Mileage before test (km) | 180,000 | | 4.5 | 10.5 | |
| Y | Manufacture year | 2001 | Embodiment III | 0 | 10.2 | 14.7 |
| | Cylinder volume (cc) | 1,600 | | | | |
| | Mileage before test (km) | 70,100 | | 4.5 | 11.7 | |
| Y | Manufacture year | 1998 | Embodiment IV | 0 | 9.5 | 17.8 |
| | Cylinder volume (cc) | 3,000 | | | | |
| | Mileage before test (km) | 163,168 | | 6.75 | 11.2 | |
| F | Manufacture year | 1990 | Embodiment V | 0 | 8 | 22.25 |
| | Cylinder volume (cc) | 1,800 | | | | |
| | Mileage before test (km) | 194,320 | | 6.75 | 9.78 | |

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. An agent for enhancing heat transfer efficiency, comprising: a nano-scale powder and a micro-scale power.

2. The agent of claim 1, wherein each particle of the nano-scale powder is formed with a particle size smaller than 100 nanometers, and each particle of the micro-scale powder is formed with a particle size ranged between 100 nanometers and 500 micrometers.

3. The agent of claim 1, wherein the total weigh of the nano-scale powder and the micro-scale power is larger than 15% of the gross weight of the enhancing agent.

4. The agent of claim 1, wherein the weigh of the scale powder is larger than 10% of the gross weight of the enhancing agent.

5. The agent of claim 1, wherein each of the nano-scale powder and the micro-scale powder is made of a material selected from the group consisting of: a metal, an alloy, a non-metallic material, a metallic compound, and a non-metallic compound.

6. The agent of claim 5, wherein the metal is a material selected from the group consisting of: titanium, vanadium, chromium, cobalt, nickel, iridium, zirconium, niobium, molybdenum, rhodium, palladium, tantalum, tungsten, platinum, silver and gold.

7. The agent of claim 5, wherein the metallic compound is substantially a transition metal oxide.

8. The agent of claim 7, wherein the transition metal oxide is a material selected from the group consisting of: titanium oxide (TiO₂), cooper oxide, iron oxide, and molybdenum oxide (MoO₂).

9. The agent of claim 5, wherein the metallic compound is substantially an alkaline earth metal compound.

10. The agent of claim 9, wherein the alkaline earth metal compound is magnesium oxide (MgO).

11. The agent of claim 5, wherein the metallic compound is substantially an oxide of a metal belonging to 13 Group of the Periodic Table.

12. The agent of claim 11, wherein the oxide of a metal belonging to 13 Group of the Periodic Table is aluminum oxide (Al₂O₃).

13. The agent of claim 5, wherein the metal compound is a material selected from the group consisting of: metal carbides and metal nitrides.

14. The agent of claim 5, wherein the non-metallic compound is a material selected from the group consisting of: carbon and graphite.

15. The agent of claim 1, being formed as a solid in a shape of any general shape, such as an button, or a pallet.

16. The agent of claim 15, being additionally doped with another additives selected from the group consisting of: a dispersant, an excipient, a disintegrant, a coloring agent, and a bacteriostatic agent.

17. The agent of claim 16, wherein the disintegrant is made of a material selected from the group consisting of: croscarmellose sodium, sodium starch glycolate, crospovidone NF, sodium carbonate, and sodium hydrogen phosphate.

18. The agent of claim 1, the agent capable of being formed alternatively as an ointment and a cream.

19. The agent of claim 18, being additionally doped with another components selected from the group consisting of: a dispersant, suspending agent, coloring agent, a bacteriostatic agent and water.
